(19) United States
(12) Patent Application Publication
(10) Pub. No.: US 2022/0119291 A1
(43) Pub. Date: Apr. 21, 2022

(54) CHLORINATED SKIMMER BASKET

(71) Applicant: INNOVATIVE WATER CARE, LLC, Alpharetta, GA (US)

(72) Inventor: David Murphy, Alpharetta, GA (US)

(21) Appl. No.: 17/502,840

(22) Filed: Oct. 15, 2021

Related U.S. Application Data
(60) Provisional application No. 63/092,210, filed on Oct. 15, 2020.

(51) Int. Cl. C02F 1/68; C02F 1/76; E04H 4/12

(52) U.S. Cl. CPC C02F 1/688; C02F 1/76; C02F 2103/42; E04H 4/1281; E04H 4/1272

(57) ABSTRACT

The invention generally relates to methods and systems for adding chemicals to a body of water through a skimmer basket in a strainer well associated with the body of water.

### RELATED APPLICATION

This application claims the benefit of and priority to U.S. Provisional No. 63/092,210, filed Oct. 15, 2020, the content of which is incorporated by reference herein in its entirety.

### FIELD OF THE INVENTION

The present invention relates to swimming pool maintenance including apparatuses and methods for transforming a traditional skimmer basket into a chlorinating skimmer basket.

### BACKGROUND

Chlorine is commonly used in swimming pools due to its disinfecting properties and, for chlorinated pools, proper maintenance requires a suitable chlorine level within the pool. To achieve the proper chlorine level, chlorine swimming pools typically employ a chlorine distribution system that traditionally falls into one of two categories.

The first category is inline distribution systems, which introduce chlorine into the pool water as it circulates through piping outside the swimming pool. More particularly, the circulating water flows through a vertical pipe that contains chlorine tablets after it flows through the external filter (e.g., a sand filter, a DE filter, a cartridge filter) and any heating systems. As such, water returning to the pool from the inline chlorinator is highly concentrated with chlorine and chlorine is introduced to the pool when the pool pump is operational.

The second type of chlorine distribution system involves a chlorinator that floats in the swimming pool. The floating chlorinator contains chlorine tablets which dissolve to disperse chlorine directly into the pool regardless of whether the pool pump is in operation. Accordingly, the floating chlorinator is a more passive system than an inline distribution system. That said, the chlorine tablets tend to dissolve more rapidly when the floating chlorinator is moving within the pool due to turbulence created around the chlorinator and the tablets.

Both types of chlorine distribution systems use chlorine tablets (a/k/a “chlorine tabs” or “tabs”) as their chlorine source and over the years the pool industry has adopted standard chlorine tab that is cylindrically shaped, with an approximately three-inch (3″) diameter and one-inch (1″) height. Traditionally, these standard tabs have been made from stabilized forms of chlorine such as dichloroisocyanuric acid (Chemical formula: C3HChN303) (a/k/a “Dichlor”) or, more frequently, trichloroisocyanuric acid (Chemical formula: C3ChN303) (a/k/a “Trichlor”).

Dichlor and Trichlor tabs contain cyanuric acid and potentially other additives in addition to pure chlorine. The cyanuric acid acts as a stabilizing agent that absorbs the sun's ultraviolet rays, which would otherwise break down and burn off the chlorine. Meanwhile, the other additives help to hold the tablet in its cylindrical form or offer other water conditioning properties.

While beneficial in some regards, cyanuric acid also has negative effects. Over time, continued use of Trichlor or Dichlor tabs can lead to a harmful buildup of cyanuric acid in the pool and research has shown increased levels of cyanuric acid decrease the chlorine's oxidation reduction potential and increase the amount of time necessary for the chlorine to kill off bacteria present in pool water. Further, if the cyanuric acid level is too high, chlorine cannot kill the most dangerous microorganisms in pool water: Cryptosporidium parvum.

Furthermore, cyanuric acid does not degrade as fast as the chlorine and requires care to prevent potentially harmful buildup. When too much cyanuric acid builds up in a pool, the typical way to reduce the buildup is by draining and refilling the pool, a costly measure with potential environmental impacts. However, cyanuric acid buildup cannot be prevented by simply adding chlorine with more Dichlor or Trichlor tabs, as doing so would continue to introduce additional cyanuric acid. For example, according to one source, for every one pound of Trichlor added, about half a pound of cyanuric acid is also added.

As a result of the potentially harmful effects cyanuric acid presents there is an ongoing debate about whether stabilized chlorine represents the best way to disinfect pools. Given the potential drawbacks associated with Dichlor and Trichlor, non-stabilized chlorine, such as calcium hypochlorite (Chemical formula: Ca(OCl)₂) (a/k/a “Cal Hypo”), has gained popularity in recent years.

Non-stabilized forms of chlorine are not new to the pool industry but, until recently, did not provide a suitable solution for continual chlorine introduction because the previous formats degraded too quickly. Historically, non-stabilized forms of chlorine were available in only granular formats that the pool industry used to “shock” treat pools. In other words, pool technicians would pour the granular nonstabilized chlorine into the pool to rapidly increase the chlorine level, but the nonstabilized chlorine would quickly dissolve and degrade, thereby losing its oxidative properties within a few hours. However, slowly dissolving non-stabilized chlorine tabs (aka “NST tabs”) made from calcium hypochlorite have now been developed, thus creating the ability to use non-stabilized chlorine as a viable option for continual chlorine delivery.

Unfortunately, transitioning from traditional stabilized chlorine tabs to NST tabs is not a matter of simply substituting one for the other. Cal Hypo is extremely reactive and mixing it with stabilized forms of chlorine presents a severe explosion risk. As such, it is inadvisable to use NST tabs in chlorine distribution systems that previously used traditional tabs because even the residual non-stabilized chlorine in the distribution apparatus could cause an explosive reaction.

### SUMMARY

To diminish the explosion risk for existing pools that have historically used stabilized chlorine, the non-stabilized tabs must be placed somewhere within the system where stabilized tabs have not been used. It has been found the ideal location for NST tab placement is within the skimmer basket for at least two reasons. First, stabilized chlorine tabs are typically not recommended for use in skimmer baskets because that type of chlorine tab tends to rapidly degrade downstream components such as the pool pump, pool filter, and pool heaters, whereas non-stabilized tabs do not. As such, there is a greater likelihood that stabilized tabs have not been used in the skimmer basket location. Second, even if someone had previously placed stabilized tabs in the skimmer basket against the recommended practices, the large amount of water flow through skimmer baskets and the body of open pool water adjacent the skimmer baskets greatly dilutes or washes

away the residual stabilized chlorine, thereby reducing the overall risk of explosion.

Nevertheless, placing NST tabs in the skimmer basket also presents some operational challenges, especially when the skimmer basket needs emptying. Typically a person removes the skimmer basket and turns the basket upside down to remove the leaves and other debris the basket catches. However, when the basket is turned over, the NST tabs in the basket, as well as any fragmented pieces thereof, are also emptied into the debris pile. Accordingly, a person emptying the debris from the skimmer basket must pick through the debris pile to find the remaining pieces of the NST tabs and place those remaining pieces back in the basket. In doing so, the person should use gloves so as not to directly touch the chlorine tab or its fragments, which increases the overall time and hassle associated with emptying unwanted debris from the strainer basket.

Systems and methods of the invention provide a separate compartment within existing strainer baskets for retaining non-stabilized chlorine tablets, isolating them from debris collected in the strainer and allowing for easy emptying of debris from the strainer basket without loss of expensive NST tablets or pieces thereof. The secondary basket can engage with the strainer basket to form a chamber containing the chemical tablets (e.g., NST tabs). When engaged, the secondary basket can allow water to access the chemical tablets via openings that, like the mesh of the strainer basket, are sized to prevent larger debris and objects from passing therethrough. Accordingly, the chemical tablets or pieces thereof remain contained within the chamber while debris is collected within the skimmer basket but outside of the chamber. A user can thereby easily empty collected debris from the skimmer basket without disturbing chemical tablets or pieces thereof within the chamber.

In order to add or remove chemical tablets to the chamber, the secondary basket can detachably engage with a surface of the skimmer basket such that, when disengaged, an opening is presented I the secondary basket through which tablets can be added or removed. The secondary basket may further comprise a handle positioned such that, when engaged with the skimmer basket, the handle is positioned toward the top of the skimmer basket, permitting easier removal of the skimmer basket from the strainer well. The interior of the secondary basket can have a cross-sectional profile similar in size and shape to the chemical tabs to be contained therein (e.g., NST tabs) and may have a height to accommodate a plurality of tablets in a stack.

In certain embodiments, an apparatus for securing NST tabs in a strainer basket is provided. It generally comprises a primary strainer basket, secondary basket, and an attachment means for removeably attaching the secondary basket to the primary strainer basket. The attachment means is preferably a separate piece mountable to the primary strainer basket so that the attachment means and the secondary basket can be offered as a kit to retrofit existing strainer baskets. With the attachment means mounted to the primary strainer basket, the secondary basket attaches to the primary strainer basket through the attachment means and provides a chamber within the primary strainer basket where the NST tabs can be located.

In some embodiments, a method of retrofitting an existing primary strainer basket with the secondary basket and attachment means, and a method of chlorinating a pool using NST tabs placed within a chamber formed by the secondary basket are disclosed herein.

Aspects of the invention include methods for chlorinating a pool. The methods may comprise providing a skimmer basket comprising a sidewall and a bottom with at least one of the sidewall and bottom comprising one or more openings for permitting water to pass therethrough while prohibiting debris from passing therethrough; placing one or more chemical tablets within the secondary basket sized to fit inside the skimmer basket; detachably engaging the secondary basket with the bottom of the skimmer basket to form a chamber on top of the bottom of the skimmer basket, the chamber containing the one or more chemical tablets, the chamber comprising one or more openings for permitting water to pass therethrough; and placing the skimmer basket and chamber containing the one or more chemical tablets in a strainer well of a pool such that the one or more chemical tablets are in contact with water therein.

In certain embodiments, the chamber can comprise a cross-sectional profile and height sized and shaped to receive a plurality of chemical tablets stacked on top of each other, wherein the placing one or more chemical tablet step comprises placing a stack of chemical tablets within the secondary basket. The one or more chemical tablets may comprise chlorine. The one or more chemical tablets can comprise non-stabilized chlorine (NST) tabs.

The secondary basket may comprise a handle positioned on a top surface opposite the bottom of the skimmer basket when detachably engaged thereto. Methods of the invention may further comprise lifting the handle on the secondary basket to remove the skimmer basket from the strainer well; removing debris captured in the skimmer basket; and returning the skimmer basket and chamber containing the one or more chemical tablets to the strainer well.

In certain embodiments, the secondary basket remains engaged with the bottom of the skimmer basket and the one or more chemical tablets remain contained within the chamber throughout the lifting, removing, and returning steps.

The secondary basket can comprise a cylindrical cross-sectional profile. The secondary basket may comprise an octagonal cross-sectional profile. The secondary basket may comprise at least one opening on a top surface opposite the bottom of the skimmer basket when detachably engaged thereto, the method further comprising observing a status of the one or more chemical tablets within the chamber through the at least one opening while the skimmer basket remains within the strainer well. The secondary basket may be detachably engaged with the bottom of the skimmer basket by an attachment means affixed to the bottom of the skimmer basket, the attachment means configured to permit the secondary basket to be detachably engaged with the bottom of the skimmer basket without using any tools. Methods of the invention may futher comprise coupling the attachment means to the bottom of the skimmer basket.

In some embodiments, the attachment means may comprise a cylindrical collar coupled to an inner surface of the bottom of the primary strainer basket, the cylindrical collar including at least one circular notch, each at least one circular notch having a wide opening and a narrow opening formed by an arced ledge. A bottom edge of a sidewall of the secondary basket can then include one or more lips configured to be inserted into the wide opening of a respective one of the at least one circular notch. In such embodiments, the detachably engaging step can comprise inserting the one or more lips of the secondary basket into the wide opening of a corresponding circular notch and then axially rotating the secondary basket to move the one or more lips of the secondary basket from the wide opening of the circular notch to the narrow opening of the circular notch.

### BRIEF DESCRIPTION OF THE DRAWINGS

FIG. 1 shows a top perspective view of an embodiment of the present invention with an NST tab located within a chamber formed by the present invention.

FIG. 2 shows a top view of the embodiment illustrating an attachment means mountable to a primary strainer basket and accompanying threaded fasteners to mount the attachment means to the primary basket.

FIG. 3 shows a bottom view of the embodiment with a driving tool attaching one of the threaded fasteners to mount the attachment means to the bottom of the primary strainer basket.

FIG. 4 shows a bottom perspective view of the embodiment with all the threaded fasteners in place to mount the attachment means to the bottom of the primary strainer basket.

FIG. 5 shows a top view of the embodiment with the attachment means mounted to the bottom of the primary strainer basket and the NST tab located within the attachment means.

FIG. 6 shows a top view of the embodiment with a secondary basket attached to the attachment means to form the chamber within the primary strainer basket around the NST tab.

FIG. 7 shows a perspective view of the attachment means comprising a collar and tabs extending from the secondary basket in the embodiment.

FIG. 8A shows a bottom plan view of the collar prior to insertion of the tabs shown in FIG. 7.

FIG. 8B shows a bottom plan view of the collar and the position of the tabs upon initial insertion of the tabs into the collar.

FIG. 8C shows a bottom plan view of the collar and the position of the tabs while rotating the secondary basket to attach the collar.

FIG. 8D shows a bottom plan view of the collar and the final position of the tabs within the collar to attach the secondary basket to the primary basket.

FIG. 9A is a partial cross section taken along section line 9A-9A from FIG. 8A.

FIG. 9B is a partial cross section taken along section line 9B-9B from FIG. 8B.

FIG. 9C is a partial cross section taken along section line 9C-9C from FIG. 8C.

FIG. 9D is a partial cross section taken along section line 9D-9D from FIG. 8D.

### DETAILED DESCRIPTION

Systems and methods of the invention generally relate to distributing chemicals into a body of water such as chlorinating a pool. In various embodiments, a secondary basket, detachably engaged to an existing skimmer basket found in strainer wells in most pools, is used to contain chemical tablets such as NST tabs. The secondary basket can be detachably engaged via an attachment mechanism that can be added to any existing skimmer basket in order to retrofit a chemical distribution system. The secondary basket creates a separate chamber to contain the tablets apart from debris that gets filtered in the skimmer basket. Accordingly, debris can be emptied out of the skimmer basket without disturbing or losing expensive chemical tablets or fragments thereof.

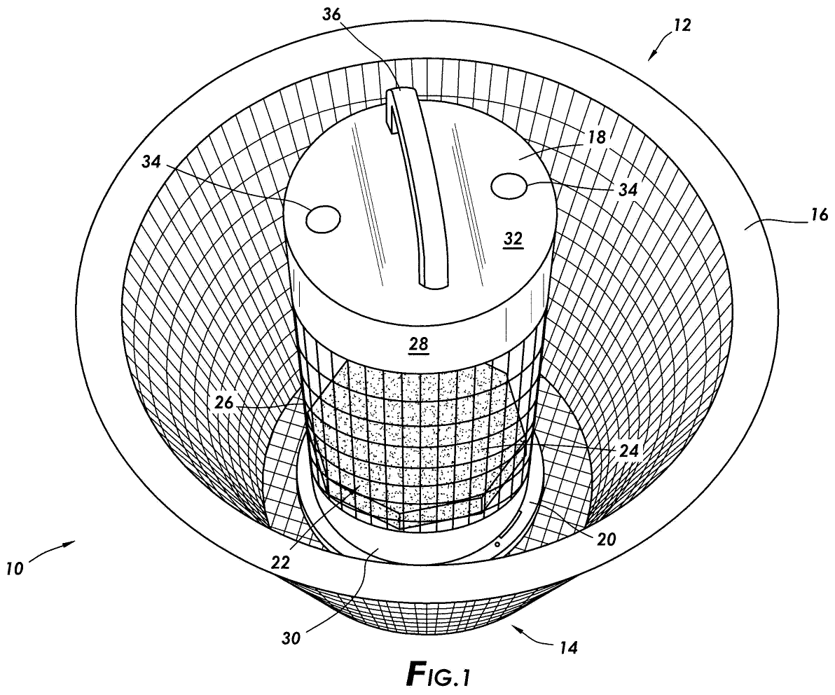

FIG. 1 illustrates an embodiment 10 of the present invention. The embodiment 10 has a top end 12 and a bottom end 14 opposite the top end 12. In general, when the embodiment 10 is placed within a strainer well of a pool (not shown), the top end 12 is nearest the entry point of the strainer well. The entry point is where a user removes a strainer well lid (not shown) to access the embodiment 10 and empty it of debris that accumulates when the pool filter (not shown) is running. In contrast, the bottom end 14 of the embodiment 10 rests against the bottom of the strainer well, where pool water enters into the external piping system of the pool (not shown) to begin its journey through the pool filter system.

As shown, the embodiment 10 generally comprises a primary strainer basket 16 and a secondary basket 18 attached to the primary strainer basket 16 through an attachment means 20. When attached to the primary strainer basket 16, a chamber 22 is formed between the secondary basket 18 and the primary strainer basket 16 where an NST tab 24 can be placed and held from falling out when the primary strainer basket 16 is turned over to empty of debris.

Preferably, the secondary basket 18 has a circumferential wall comprising a mesh perimeter 26 bounded by a first solid wall section 28 and a second solid wall section 30. The first solid wall section 28 terminates into a closed end wall 32 at the top end 12. The end wall 32 may have vent holes 34 disposed therein to provide a pathway for trapped air to escape when the embodiment 10 is placed within the skimmer well of a pool (not shown), thereby reducing its buoyancy. Meanwhile, the mesh perimeter 26 allows pool water to flow through the chamber 22 and over the NST tab 24 therein.

Additionally, the secondary basket 18 in the embodiment 10 has a handle 36 affixed to the end wall 32. When present, the handle 36 provides an area where the embodiment 10 can be grabbed to lift it out of the strainer well (not shown) of a pool for purposes of emptying the primary strainer basket 16. The handle 36 also provides an area for a user to grab while removing the secondary basket 18 from and attaching the secondary basket 18 to the primary strainer basket 16 through the attachment means 20 as herein described.

Preferably, the circumference of the secondary basket 18 circumferential wall slightly increases as the wall extends from the intersection of the end wall 32 and the first wall section 28 to the second wall section 30. As such, the preferred secondary basket has an overall frustoconical shape. However, the secondary basket 18 may be shaped differently in alternative embodiments (e.g., as a true cylinder, pyramid, square tube, etc.) so long as the chamber 22 created is large enough to accommodate at least one NST tab 24.

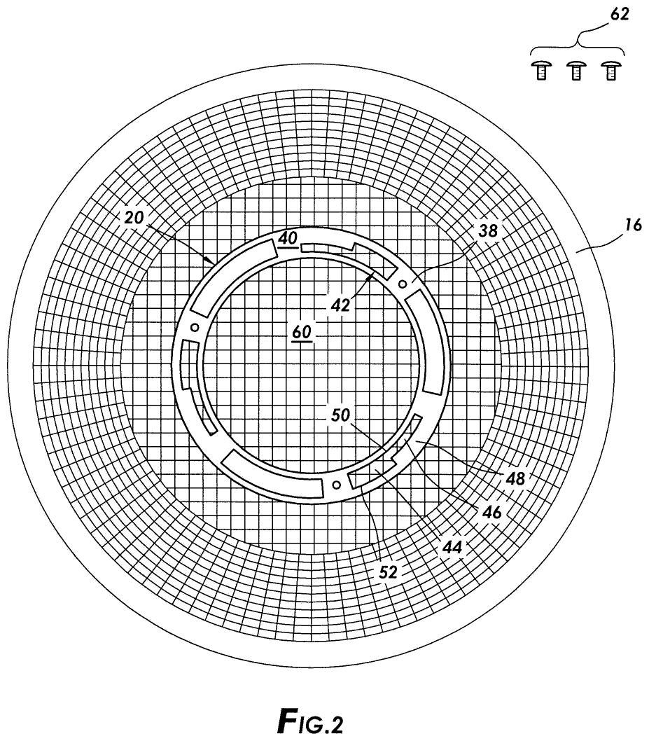

In FIG. 2, the secondary basket 18 has been removed to help illustrate the preferred attachment means 20 in the embodiment 10. Preferably, the attachment means 20 comprises a cylindrical collar 38 having a top surface 40 with one or more notches 42 disposed therein. The notches 42 have a wide opening 44 and a narrow opening 46 formed by an arced ledge 48. In this regard, the wide opening 44 and the narrow opening 46 share a common inner arced sidewall 50, and the narrow opening is between the ledge 48 and the inner arced sidewall 50 while the wide opening 44 is between the inner arced sidewall 50 and an outer arced sidewall 52. As shown, the narrow opening 46 is approximately one half of the area of the wide opening 44.

FIG. 2 also shows the preferred placement of the cylindrical collar 38. The collar 38 is located on a bottom surface 60 of the primary strainer basket 16. The bottom surface 60 is preferably a mesh surface having a generally circular overall shape. As shown, the collar 38 is located concentric with circular bottom surface 60 so that the center of the collar 38 and the center of the circular bottom surface 60 are co-located together. However, the collar 38 or an alternative attachment means 20 may be located elsewhere on the bottom surface 60, or elsewhere on the primary strainer basket 16, in alternative embodiments.

It should here be noted, that the attachment means 20 may take another form in alternative embodiments. The attachment means 20 is any structure through which the secondary basket 18 attaches to the primary strainer basket 16 in a manner which allows attachment and detachment of the secondary basket 18 from the primary strainer basket 16 to be accomplished without the need of hand tools (e.g., screwdrivers, pliers, wrenches, etc.). For example, the attachment means 20 could constitute a threaded attachment between the collar 38 and the secondary basket 18, an interference fit between the collar 38 and the secondary basket 18, a ball detent or other type of clicking system attachment, a clamping attachment, an attachment secured with one or more protrusions that fit within corresponding notches similar to the way an automatic pool cleaner net attaches to the pool cleaner or a bayonet base lightbulb attaches in an automobile taillight, a magnetic attachment, or a hook and loop attachment, as well as other forms of attachment appreciated by those having ordinary skill in the art.

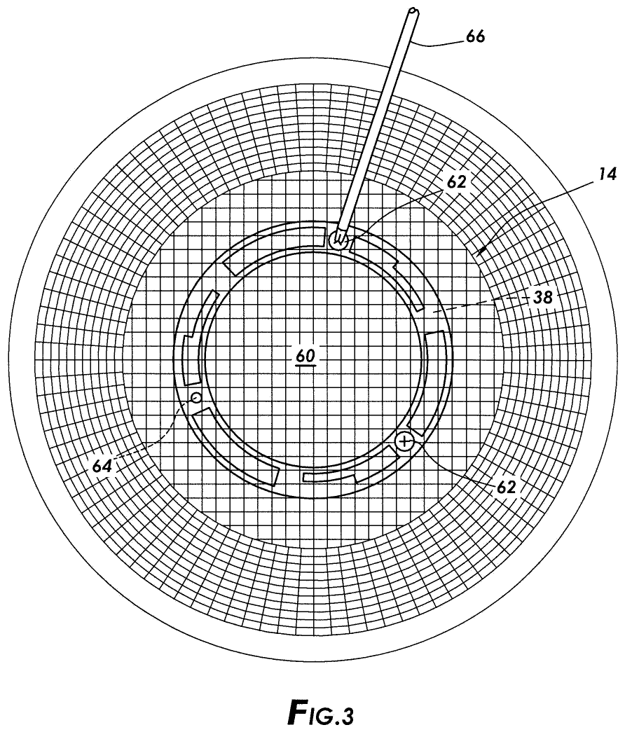

Also shown in FIG. 2 are threaded fasteners 62 used to mount the collar 38 to the bottom surface 60 of the primary strainer basket 16. In this regard, a user (not shown) holds the collar 38 against the bottom surface 60 while turning over the strainer basket 16 to expose the bottom end 14, as shown in FIG. 3. Once the bottom end 14 is exposed, the threaded fasteners 62 are inserted into the bottom end 14, through the mesh bottom surface 60, and into a receptacle 64 disposed in the collar 38. A screwdriver 66 or other applicable fastener driving tool, depending on the form of the threaded fasteners 62, is then used to tighten the threaded fasteners 62.

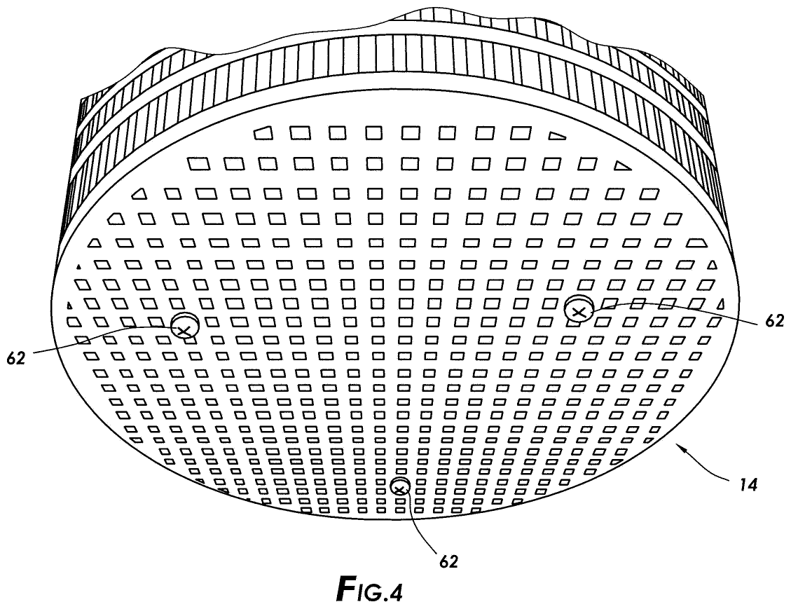

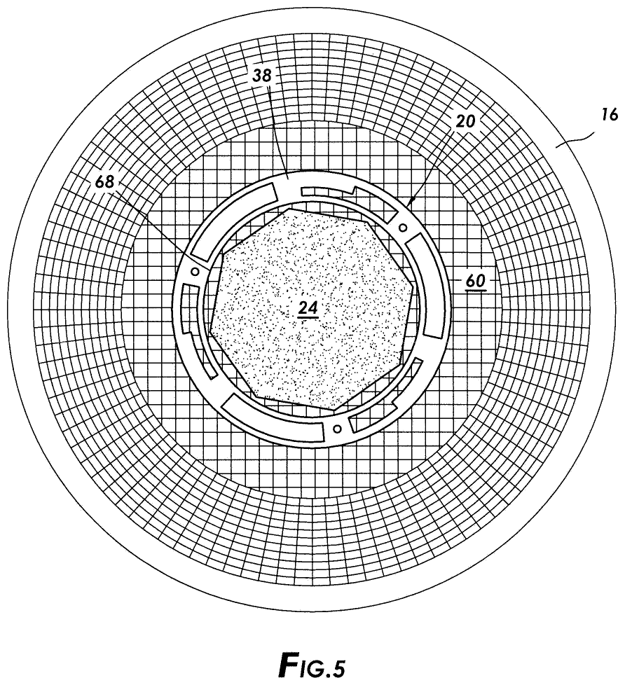

FIG. 4 shows the bottom end 14 with all the threaded fasteners 62 in place. The mesh depicted in FIG. 4 is a mesh common to commercially available strainer baskets, and the shaft (not shown) of the threaded fasteners 62 extends through one of the open spaces within the mesh. In contrast, the head of the threaded fasteners 62 is too large to pass through the open spaces of the mesh, and abuts against non-open portions of the mesh. Accordingly, the collar (not shown) is drawn toward the bottom surface 60 on the opposite side of the bottom end 14, thereby mounting the collar 38 to the bottom surface 60 of the primary strainer basket 16 as shown in FIG. 5.

FIG. 5 also shows the NST tab 24 placed partially within an inner circumference 68 of the cylindrical collar 38. Accordingly, the cylindrical collar 38 in the embodiment 10 at least partially forms the chamber 22 within which the NST tab 24 is located in FIG. 1. The standard NST tab 24 is shaped as a regular octagon having an equal length and width, which measures approximately 2 13/16″ from straight-edge to straight-edge across the octagon, approximately 3″ from vertex to vertex across the octagon, and approximately 1½ “tall. Thus, to accommodate the standard NST tab 24 within the cylindrical collar 38, the inner circumference 68 is preferably approximately 3¼” in diameter.

It should here be noted, however, the NST tab 24 may not be within the collar 38 in alternative embodiments. For example, the NST tab 24 may be located entirely within the secondary basket 18 depending on the form of the particular attachment means 20.

Within the inner circumference 68, the NST tab 24 rests against the mesh bottom surface 60 of the primary strainer basket 16. Depending on the size of the secondary basket 18, one or more additional NST tabs (not shown) may also be stacked on top of tab 24. With the tab 24 or tabs located as such, water from the pool flows over the tab 24 (or tabs), through the mesh bottom surface 60, and into the exterior piping system (not shown). As the water flows over the NST tab 24 it dissolves the tab, which increases the chlorine concentration in the water stream back to the pool filter (not shown).

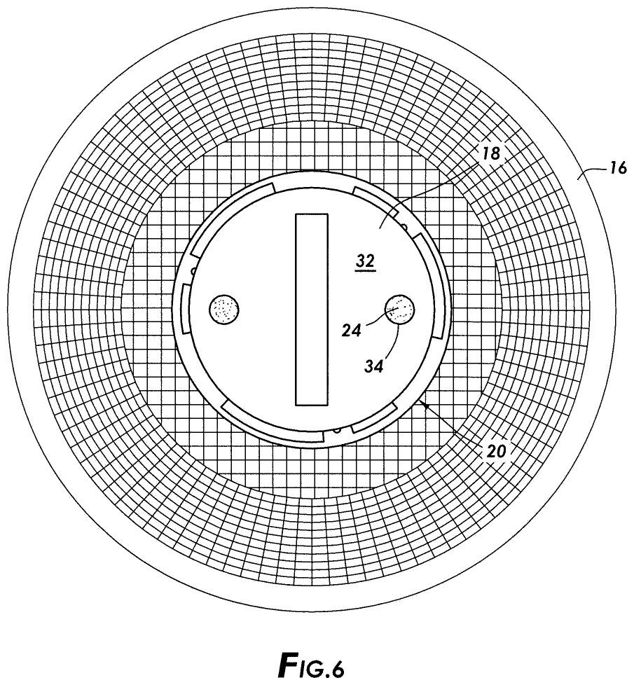

Once the NST tab 24 is in place within the inner circumference 68, the secondary basket 18 is attached to the primary basket 16 through the attachment means 20. As shown in FIG. 6, the end wall 32 of the secondary basket 18 covers the tab 24, which can be seen through the vent holes 34. The interior of the secondary basket 18 is also sized to receive at least a portion of the tab 24, thereby forming or at partially forming the chamber 22 within which the tab 24 is located as shown to FIG. 1.

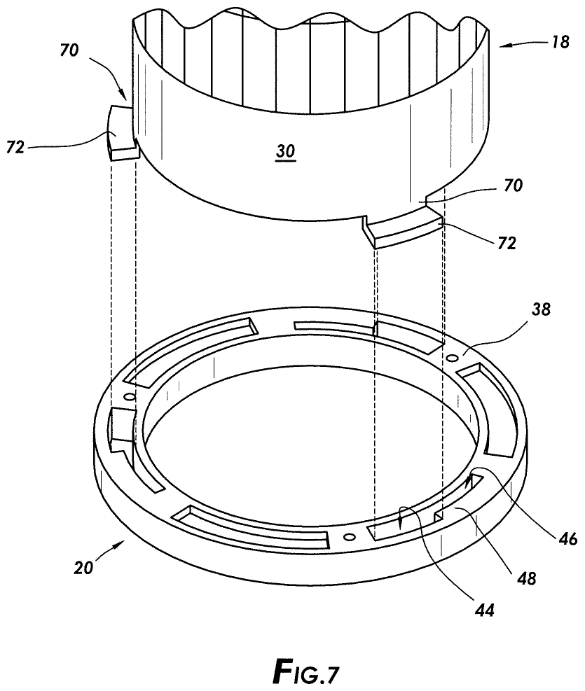

FIG. 7 further illustrates the preferred attachment means 20. As shown, the secondary basket 18 has one or more tabs 70 extending from its solid wall section 30 and, here, a total of three tabs 70 are present, with two tabs 70 being visible and the third tab obscured behind the wall section 30. Each of the tabs 70 has a lip 72 that extends radially outward of the wall section 30. As shown by the dotted lines, each of the tabs 70 is displaced into one of the corresponding notches 42 in the collar 38, with the lip 72 inserted into the wide opening 44. As will be seen, the secondary basket 18 is then axially rotated so that the tabs 70 are positioned within the narrow opening 46, with the lip 72 below the ledge 48, thereby interlocking the secondary basket 18 with the collar 38.

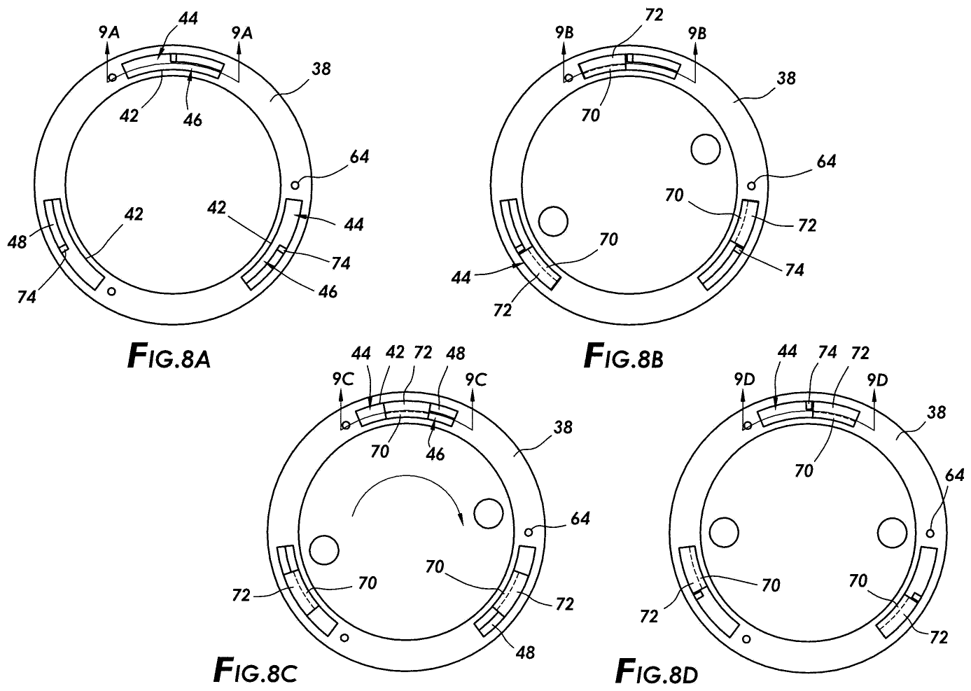

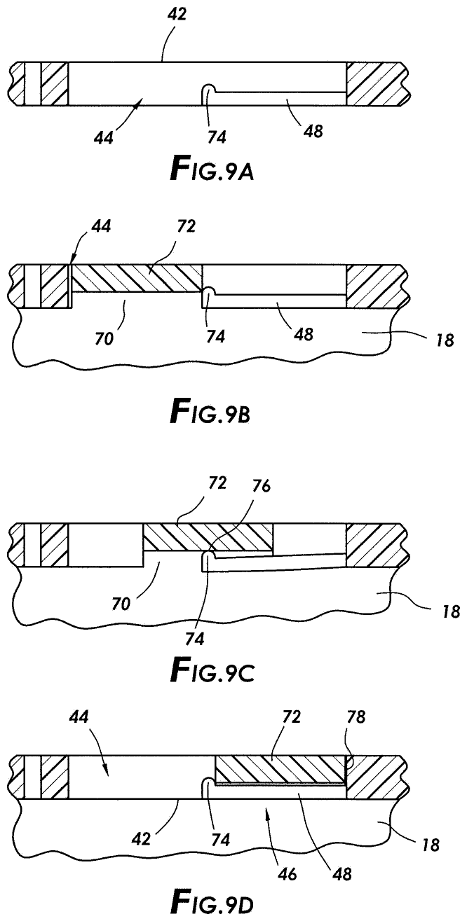

FIGS. 8A-8D show the progression of the lip 72 for each of the tabs 70 as the secondary basket 18 is interlocked with the collar 38. This view is taken from the bottom of the collar 38, so each receptacle 64 is shown. Dotted lines are inserted between lip 72 and the tabs 70 for illustration purposes to generally show a delineation between the two, but in practice each lip and tab are preferably a single, integral piece. Additionally, FIGS. 9A-9B show cross-sectional views that correspond to the positioning of the lip 72 in FIGS. 8A-8D, respectively, as the secondary basket 18 is attached.

It should here be noted that each of the notches 42 in the embodiment 10 are identically formed, as are each of the tabs 70, so a description of one tab or notch applies equally to the other tabs or notches. However, the notches 24 and tabs 70 may not be identical in alternative embodiments.

In FIG. 8A, the tabs 70 have not been inserted into the notches 42, so the wide opening 44 and the narrow opening 46 are not occupied. Accordingly, FIG. 9A shows one of the notches 42 in cross section and nothing occupies the wide opening 44. FIG. 9A also shows the ledge 48 and a locking shoulder 74 disposed on the ledge 48 adjacent the wide opening 44, which is also shown in FIG. 8A.

In FIG. 8B, the lip 72 for each of the tabs 70 has been inserted into the wide opening 44 and is adjacent the locking shoulder 74. Referring to FIG. 9B, the lip 72 is adjacent the locking shoulder 74 and extends slight past the shoulder 74.

In FIG. 8C, the secondary basket 18 has been axially rotated approximately halfway to its final resting location. Accordingly, the lip 72 on each of the tabs 70 is depicted in the middle of the notches 42, with part of the wide opening 44 shown on one side of the lip 72 and the narrow opening 46 and ledge 48 shown on the other side of the lip 72. As shown in corresponding FIG. 9C, the lip 72 is positioned on an arced surface 76 of the locking shoulder 74 and the extension of the lip 72 past the locking shoulder 74 previously discussed, slightly displaces the ledge 48 while traveling past the shoulder 74.

In FIG. 8D, the secondary basket 18 has been axially rotated to its final resting location. Accordingly, the lip 72 on each of the tabs 70 is depicted on the other side of the locking shoulder 74 as compared to FIG. 8B. Accordingly, as best shown in FIG. 9D, the lip 72 is positioned in the narrow opening 46, between the locking shoulder 74 and a sidewall 78 of the notch 42, with the locking shoulder 74 helping hold the lip 72 in place. Further, the ledge 48 is positioned below the lip 72 in this bottom view, but when the embodiment is in use, ledge 48 would be positioned above the lip 72, thereby holding the lip 72 below the ledge 48. Accordingly, with each lip 72 in a similar location and the collar 38 mounted to the primary strainer basket 16 as previously described, the secondary basket 18 is attached to the primary strainer basket 16.

To chlorinate a pool using the above-described apparatus, a user removes the apparatus from the strainer well (not shown) of the pool and detaches the secondary basket 18 from the primary strainer basket 16. The user places an NST tab 24 on the bottom surface 60 of the primary basket 16 and reattaches the secondary basket 18 to the primary basket 16 through the attachment means 20, with the secondary basket 18 over the NST tab 24 and the NST tab 24 being located within the chamber 22 formed, or at least partially formed, by the interior of the secondary basket 18. The user then places the primary strainer basket 16 back into the strainer well and turns the pool pump on for normal operation. As previously noted, the present invention also contemplates a kit to retrofit existing strainer baskets. In this regard, the secondary basket 18 may be sold along with the attachment means 20, without the primary strainer basket 16. The attachment means 20 would be mountable to the primary strainer basket 16 so that the secondary basket 18 can be attached and detached from the primary basket 16 without the need for hand tools. For example, following the present embodiment 10, the secondary basket 18 would be sold along with the collar 38 and the threaded fasteners 62, so the collar 38 could be mounted to a primary strainer basket 16 that is already being used in a pool.

The invention may be embodied in other specific forms without departing from the spirit or essential characteristics thereof. The foregoing embodiments are therefore to be considered in all respects illustrative rather than limiting on the invention described and claimed herein.

What is claimed is:

1. A method for chlorinating a pool, the method comprising:
providing a skimmer basket comprising a sidewall and a bottom with at least one of the sidewall and bottom comprising one or more openings for permitting water to pass therethrough while prohibiting debris from passing therethrough;
placing one or more chemical tablets within a secondary basket sized to fit inside the skimmer basket;
detachably engaging the secondary basket with the bottom of the skimmer basket to form a chamber on top of the bottom of the skimmer basket, the chamber containing the one or more chemical tablets, the chamber comprising one or more openings for permitting water to pass therethrough while prohibiting debris from passing into the chamber; and
placing the skimmer basket and the detachably engaged chamber containing the one or more chemical tablets in a strainer well of a pool such that the one or more chemical tablets can contact water therein.

2. The method of claim 1, wherein the chamber comprises a cross-sectional profile and height sized and shaped to receive a plurality of chemical tablets stacked on top of each other, wherein the placing one or more chemical tablet step comprises placing a stack of chemical tablets within the secondary basket.

3. The method of claim 2, wherein the one or more chemical tablets comprise chlorine.

4. The method of claim 3, wherein the one or more chemical tablets comprise non-stabilized chlorine (NST) tabs.

5. The method of claim 1, wherein the secondary basket comprises a handle positioned on a top surface opposite the bottom of the skimmer basket when detachably engaged thereto, the method further comprising:
lifting the handle on the secondary basket to remove the skimmer basket from the strainer well;
removing debris captured in the skimmer basket; and
returning the skimmer basket and chamber containing the one or more chemical tablets to the strainer well.

6. The method of claim 5, wherein the secondary basket remains engaged with the bottom of the skimmer basket and the one or more chemical tablets remain contained within the chamber throughout the lifting, removing, and returning steps.

7. The method of claim 1, wherein the secondary basket comprises a cylindrical cross-sectional profile.

8. The method of claim 1, wherein the secondary basket comprises an octagonal cross-sectional profile.

9. The method of claim 1, wherein the secondary basket comprises at least one opening on a top surface opposite the bottom of the skimmer basket when detachably engaged thereto, the method further comprising observing a status of the one or more chemical tablets within the chamber through the at least one opening while the skimmer basket remains within the strainer well.

10. The method of claim 1, wherein the secondary basket is detachably engaged with the bottom of the skimmer basket by an attachment means affixed to the bottom of the skimmer basket, the attachment means configured to permit the secondary basket to be detachably engaged with the bottom of the skimmer basket without using any tools.

11. The method of claim 10, further comprising coupling the attachment means to the bottom of the skimmer basket.

12. A system comprising:
a primary strainer basket sized and shaped to be placed in a strainer well of a pool, the primary strainer basket comprising a mesh sidewall shaped to fit in the strainer well and a mesh bottom, the mesh sidewall and mesh bottom thereby permitting pool water to pass through the sidewall and bottom of the primary strainer basket while retaining debris;
a secondary basket sized and shaped to fit inside the primary strainer basket and also configured to be detachably engageable with the mesh bottom of the primary strainer basket to form a chamber; and
one or more chemical tablets located within the chamber.

13. The system of claim 12, wherein the one or more chemical tablets comprise a non-stabilized chlorine tab (NST tab).

14. The system of claim 12, wherein the secondary basket comprises:
a cylindrical mesh sidewall that permits pool water to pass therethrough;
a top solid wall section affixed to a top periphery of the cylindrical mesh sidewall, the top solid wall section forming a closed top end wall for the secondary basket, the closed top solid wall section including a handle on a top surface for lifting the secondary basket; and
a bottom solid wall affixed to a periphery of a bottom end of the cylindrical mesh sidewall such that the bottom of the secondary basket is open, the bottom solid wall being configured to permit the secondary basket to be selectively attached/detached with the bottom mesh of the primary strainer basket.

15. The system of claim 14, wherein a height of the secondary basket permits a plurality of NST tabs to be stacked inside the chamber formed by the secondary basket when the secondary basket is attached to the bottom mesh of the primary strainer basket.

16. The system of claim 14, wherein the NST tab has a standard shape of an octagon that is approximately three inches at a longest dimension from vertex to vertex across the octagon, and wherein a diameter of the cylindrical mesh sidewall of the secondary basket and a diameter of the bottom solid wall affixed to the periphery of the bottom end of the cylindrical mesh sidewall are sized to accommodate the octagon-shaped NST tab.

17. The system of claim 14, wherein the top solid wall section of the secondary basket has at least one vent hole through which can be viewed an NST tab being held within the chamber being formed by the secondary basket.

18. The system of claim 12, further comprising an attachment means affixed to the mesh bottom of the primary strainer basket, the attachment means configured to permit the secondary basket to be selectively attached/detached from the primary strainer basket without using any tools.

19. The system of claim 12, wherein the secondary basket comprises an octagonal cross-sectional profile.

20. The system of claim 14, wherein the top solid wall comprises at least one opening sized and positioned to permit observation of the one or more chemical tablets within the chamber when the skimmer basket is within the strainer well of the pool.
